(19) United States
(12) Patent Application Publication
(10) Pub. No.: US 2013/0253976 A1
(43) Pub. Date: Sep. 26, 2013

(54) SYSTEM AND METHOD FOR PROCESSING ELECTRONIC MAILS IN A HIGH VOLUME SHARED SERVICES ENVIRONMENT FOR INITIATING AND PROCESSING TRANSACTIONS

(71) Applicants: JAGDEESH SHUKLA, Pune (IN); LALITHA RAMANI, Bangalore (IN); INDRANIL BERA, Bangalore (IN)

(72) Inventors: JAGDEESH SHUKLA, Pune (IN); LALITHA RAMANI, Bangalore (IN); INDRANIL BERA, Bangalore (IN)

(21) Appl. No.: 13/592,388

(22) Filed: Aug. 23, 2012

(30) Foreign Application Priority Data
Mar. 20, 2012 (IN) 1016/CHE/2012

(51) Int. Cl. G06Q 10/10

(52) U.S. Cl. 705/7.26

(57) ABSTRACT

A system and method for processing electronic mails (emails) in a high volume shared services environment for initiating and processing transactions are disclosed. In one embodiment, business data is extracted by parsing data in a received email. Further, associated one or more business processes are determined based on the extracted business data. Furthermore, associated one or more business process transactions are initiated based on the determined one or more business processes. In addition, the one or more business process transactions are routed to the associated one or more business process transaction queues. Moreover, the routed one or more business process transactions are executed.

Benefit is claimed under 35 U.S.C 119(a)-(d) to Indian Application Serial No. 1016/CHE/2012 entitled “SYSTEM AND METHOD FOR PROCESSING ELECTRONIC MAILS IN A HIGH VOLUME SHARED SERVICES ENVIRONMENT FOR INITIATING AND PROCESSING TRANSACTIONS” filed on Mar. 20, 2012 by Wipro Limited.

### TECHNICAL FIELD

Embodiments of the present subject matter relate to an automated computer processing of electronic mails (emails). More particularly, embodiments of the present subject matter relate to automated computer processing of the emails in a high volume shared services environment.

### BACKGROUND

Handling electronic mail (email) data has gained importance in the information age and more recently with the explosion of electronic data in all walks of life including, among others, emails, text data, images, scanned documents and the like. One area just starting to be explored is automated (non-manual) classification of data and its further processing for an identified business purpose.

In shared services back office processing scenarios that also include business process outsourcing (BPO) scenarios, with the growing volumes of business happening through the emails as queries, feedbacks, decisions, resolutions and the like, handling such mode of communication can be a significant challenge. Further, in the shared services context, a significant amount of input, further communication, exception management and resolution happens through the emails. This is even more accentuated in back office scenarios like invoice processing and helpdesk queries handling. In such situations, an input email acts as a trigger to create one or more new transactions (jobs or work items) for an operations floor. These newly created work items need to be first classified (pre-indexing), then needed data is inputted into the transaction from the attachments (indexing) and then finally processed. Currently, these steps are human effort intensive, time consuming and repetitive and may be very error prone and result in not completing the transactions on time and may further result in financial and non-financial implications to an organization because of agreed upon service level agreements (SLAs). It can be seen that such problems can get significantly amplified in a high volume shared services environment.

Existing solutions can auto-create a job from an incoming email including attachments in the email as input documents. However, information embedded in these input documents need further manual intervention to copy them into job details either by using optical character recognition (OCR) or completely manually. Further, existing solutions can only handle extracting information from body of the email when received in templatized inputs (i.e., where information is received in a predetermined and/or structured format) to auto-create the job and to further process the job. Furthermore, the existing solutions cannot give a balance between automation and agent's manual intervention and also the ability to override the system-driven parsing of information.

### SUMMARY

A system and method for processing electronic mails (emails) in a high volume shared services environment for initiating and processing transactions are disclosed. According to one aspect of the present subject matter, a received email is validated for further processing. Further, the validated email is routed to extract business data upon successful validation. Furthermore, the business data is extracted by parsing data in the received email. In addition, the extracted business data is transformed into structured business data using transformation rules. Also, any needed additional business data is computed from the transformed business data. Moreover, a confidence level is assigned to the transformed business data.

Further, associated one or more business processes are determined based on the transformed business data and the associated confidence level. Furthermore, associated one or more business process transactions are initiated based on the determined one or more business processes. In addition, the one or more business process transactions are routed to the associated one or more business process transaction queues. Moreover, the routed one or more business process transactions are executed based on the confidence level associated with the business data and business data thresholds. Also, the transformation rules are updated to obtain an enhanced confidence level for a next business process transaction.

According to another aspect of the present subject matter, an email management system (EMS) includes a processor, memory coupled to the processor, and an email management engine residing in the memory. Further, the email management engine includes a gateway services engine, an identification engine, an execution engine, and a rules engine. In one embodiment, the gateway services engine validates the received email for further processing. Further, the gateway services engine routes the validated email to extract the business data upon successful validation. Furthermore, the gateway services engine extracts the business data by parsing the data in the validated email. In addition, the identification engine transforms the extracted business data into the structured business data using the transformation rules. Moreover, the identification engine computes any needed additional business data from the transformed business data. Also, the rules engine assigns the confidence level to the transformed business data.

Also, the identification engine determines associated one or more business processes based on the transformed business data and the associated confidence level. Further, the identification engine initiates associated one or more business process transactions based on the determined one or more business processes. Furthermore, the execution engine routes the one or more business process transactions to the associated one or more business process transaction queues. In addition, the execution engine executes the routed one or more business process transactions based on the confidence level associated with the business data and the business data thresholds. Also, the identification engine updates the transformation rules to obtain the enhanced confidence level for the next business process transaction.

According to yet another aspect of the present subject matter, a non-transitory computer-readable storage medium for processing the emails in the high volume shared services environment for initiating and processing transactions, having instructions that, when executed by a computing device causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flowchart of a computer implemented method for processing electronic mails (emails) in a high volume shared services environment to initiate and process transactions, according to one embodiment;

FIGS. 2A-B illustrates flowcharts of a computer implemented method for processing the emails in the high volume shared services environment to initiate and process the transactions, according to another embodiment;

FIG. 3 illustrates an example email received in the high volume shared services environment; and

FIG. 4 illustrates an email management system (EMS) including an email management engine for processing the emails in the high volume shared services environment to initiate and process the transactions, using the processes described with reference to FIGS. 1 and 2A-B, according to one embodiment.

The drawings described herein are for illustration purposes only and are not intended to limit the scope of the present disclosure in any way.

### DETAILED DESCRIPTION

A system and method for processing electronic mails (emails) in a high volume shared services environment for initiating and processing transactions are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The term “shared services” refers to an operational philosophy that involves centralizing those business process functions (services) of a company that were once performed in separate divisions or locations. Services that can be shared among the various business units of the company include finance, purchasing, inventory, payroll, hiring, and information technology.

Further, the term “transaction” in a shared services environment is an atomic (indivisible) single unit of work that must be completed in transaction based processes like finance and accounting, helpdesk or procurement functions. For example, in a human resource helpdesk process, transaction refers to addressing each employee request raised. In an invoice processing scenario, transaction refers to completing the processing of each invoice. Furthermore, the terms “transaction”, “job” and “work item” are used interchangeably throughout the document.

Typically, each transaction can be made up of many activities or steps. Most of these transactions, in the shared services environment, require interactions with user(s) for missing information, follow-ups with various other departments, approvals, exceptions, errors and the like. In a shared service scenario, some of these steps of a transaction type may be common across such transactions and some of the steps may have variations depending upon factors like originating department. This adds into complexity of transaction processing.

In addition, the term “electronic mail” refers to emails including structured data and/or unstructured data in the body of the emails and the one or more attached documents (i.e., documents including content in free form, such as bitmap images/objects, text files with free form text and other non-standard data types). Also, the term “structured data” refers to data that is organized in a structure so that it is identifiable and searchable by a data type and can be used as variables in a processing logic.

Moreover, the term “unstructured data” refers to data that has no identifiable structure (i.e., free form text without any structure) and cannot be easily identified or searched. The unstructured data is raw data that needs text mining and further parsing to decompose it into a set of structured data elements.

The unstructured data when parsed generates words, keywords used, frequency of usage of certain words and the like. However, it is difficult to decipher useful information, such as type of embedded business data, service type information, email tone information and the like.

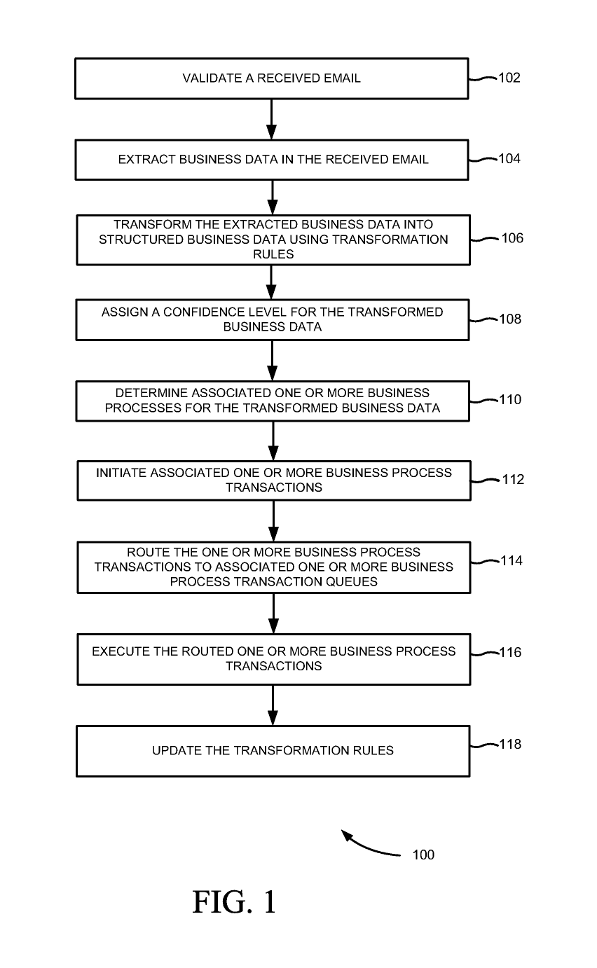

FIG. 1 illustrates a flowchart 100 of a computer implemented method for processing emails in a high volume shared services environment to initiate and process transactions, according to one embodiment. At block 102, a received email is validated for further processing. In one exemplary implementation, the received email is validated based on a set of functional rules and attributes, such as the received email should have at least one attachment and the like and a set of relevant parameters, such as relevant sources or pre-defined set of vendors, out of office emails, ignoring auto- generated emails and the like. The validated email is then routed to extract business data upon successful validation.

At block 104, the business data is extracted by parsing data in the validated email. For example, the data includes structured data and/or unstructured data. For example, the structured data can include attributes of the email, such as date and time on which the email was sent, whether the received email includes an attachment, email sender details, an email subject line and the like, attributes of the attachments, such as an attachment type (e.g., a word document, a text document, a spreadsheet and so on) and the like, and pre-defined templates, such as keywords in the email subject line, pre-defined email body templates or web-forms, data in specific columns and rows of an attached spreadsheet and the like. For example, the unstructured data can be the email body of the message free form text without any structure, attachments, such as bitmap images/objects, text files with free form text and the like and other non-standard data types.

In one embodiment, the business data is extracted by parsing the data in the validated email using industry standard text extraction algorithms. For example, parsing the data includes parsing email header text, email body text, text from one or more embedded files/images, text from one or more attached documents and the like. Exemplary documents include files containing text. At block 106, the extracted business data is transformed into structured business data (i.e., understandable business entities). In one exemplary implementation, the extracted business data is transformed into the structured business data using transformation rules. Further, any needed additional business data is computed from the transformed business data. At block 108, a confidence level is assigned to the transformed business data. In one embodiment, relevant business data is determined from the transformed business data. Further, associated one or more rules are determined for validating and applicability of the determined relevant business data. Furthermore, the determined one or more rules are compared with the relevant business data. In addition, the confidence level is assigned to the relevant business data based on the outcome of the comparison.

At block 110, associated one or more business processes are determined based on the extracted business data and the associated confidence level. At block 112, associated one or more business process transactions are initiated based on the determined one or more business processes. At block 114, the one or more business process transactions are routed to the associated one or more business process transaction queues. For example, routing the one or more business process transactions includes allocating and sending the one or more business process transactions to a right path, to a right queue, and to a right user. At block 116, the routed one or more business process transactions are executed based on the confidence level associated with the business data and business data thresholds. In one embodiment, the routed one or more business process transactions are executed using proprietary best practices based on the confidence level associated with the business data and the business data thresholds.

In one embodiment, the one or more business process transactions are executed automatically or manually. In one exemplary implementation, the one or more business process transactions are automatically executed based on classification and indexing parameters, such as automatically responding using standardized templates, automatically escalating using standardized templates, automatically upgrading priorities of jobs, raising alerts to pre-configured people with pre-defined urgency levels, automatically approving based on values and pre-defined thresholds, automatically sending for approval to designated authorities and the like. At block 118, the transformation rules are updated to obtain an enhanced confidence level for a next business process transaction.

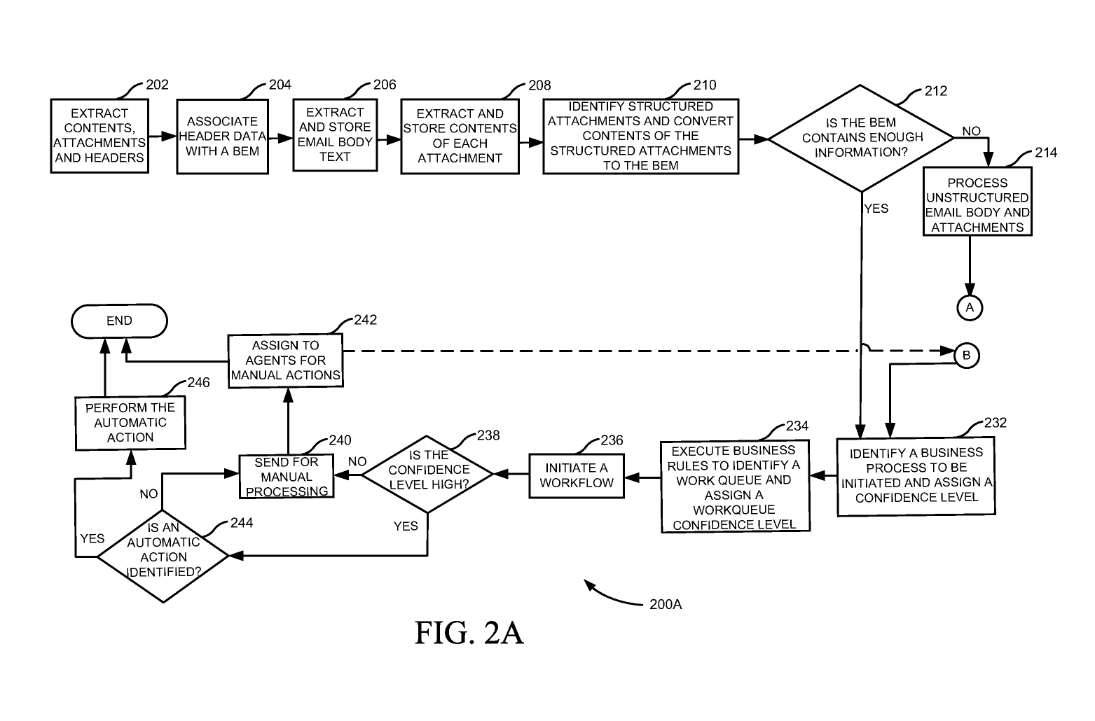

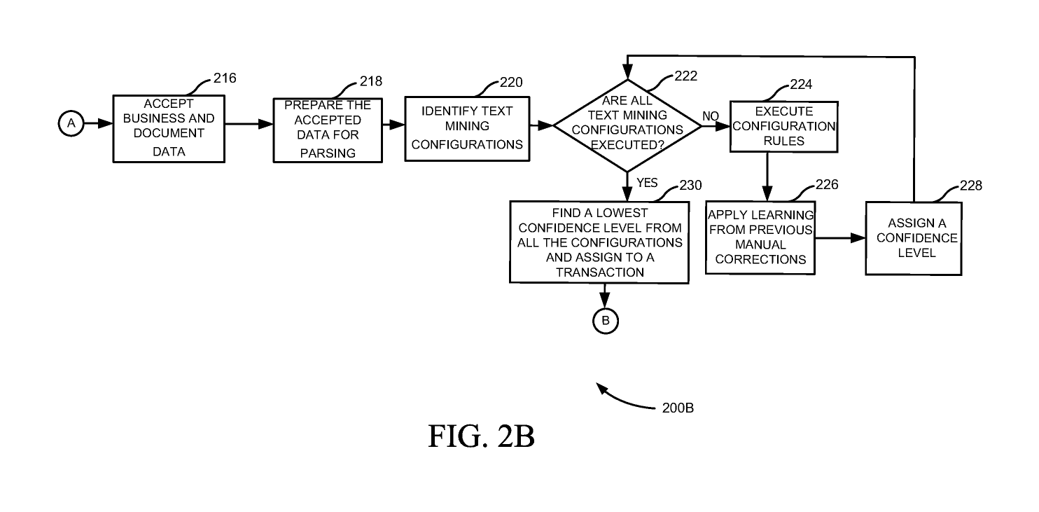

Referring now to FIGS. 2A-B, which illustrates flowcharts 200A-B of a computer implemented method for processing emails in a high volume shared services environment to initiate and process transactions, according to another embodiment. At block 202, contents, attachments and headers of a received email are extracted by parsing data in the received email. Exemplary data includes structured data and/or unstructured data. In one embodiment, the received email is validated for further processing. For example, the received email is validated based on a set of functional rules and attributes, such as the received email should have at least one attachment, the received email should be from a known set of email identities (IDs) and the like and a set of relevant parameters, such as relevant sources or pre-defined set of vendors, out of office emails, ignoring auto-generated emails and the like. Further, the contents, attachments and headers are extracted from the validated email by parsing the data upon successful validation.

At block 204, header data is associated with a business entity model (BEM) in the high volume shared service environment. For example, the BEM is defined or configured by a process modeler when requirements are captured. Typically, the BEM includes all fields that are relevant to a business process. Exemplary header data includes a subject line of the received email, data and time of receipt and the like. At block 206, email body text is extracted and temporarily stored for further processing. At block 208, contents of each attachment in the received email are extracted by parsing the data in each attachment. Further, the extracted contents are temporarily stored for further processing. For example, the attachments may include office documents, such as word documents, spreadsheets and the like, portable document formats (PDFs), images, such as a tagged image file format (TIFF), joint photographic experts group (JPEG), etc., and the like. For example, contents of each attachment are extracted by reading each attachment.

At block 210, structured attachments in the received email are identified based on the predefined templates and/or configurations. Further, contents of the structured attachments are extracted and converted to the BEM. At block 212, it is identified whether the BEM includes enough information for further processing. At block 214, unstructured email body and attachments are processed if the BEM does not include enough information for further processing. At block 216, business and document data of the unstructured email body and attachments are accepted. For example, text from the received email body and business documents is accepted. At block 218, the accepted data is prepared for parsing.

At block 220, text mining configurations for the accepted data are identified. For example, each text mining configuration is an implementation of supervised learning pattern recognition using existing technologies. Further, each text mining configuration works on a set of sample data with acceptable output and a probability of success. At block 222, it is determined whether all the text mining configurations are executed. At block 224, configuration rules (e.g., pattern recognition rules) are executed on the accepted data if all the text mining configurations are not executed. For example, the configuration rules include keywords, a set of words, and the like. At block 226, learning is applied from previous manual corrections. For example, learning from the previous manual corrections is fed back to the accepted data and store for further fine tuning. At block 228, a confidence level is assigned to the data and the process steps from block 222 are then repeated.

At block 230, a lowest confidence level is identified from all the text mining configurations and assigned to the transaction if all the text mining configurations are executed. At block 232, a business process to be initiated is identified and a confidence level is assigned if the BEM includes enough information for further processing and upon identifying the lowest confidence level from all the text mining configurations. In one embodiment, an error is reported if the business process is not identified. At block 234, a work queue is identified by executing business rules on the business process and a work queue confidence level is assigned. At block 236, a workflow is initiated. In one embodiment, a sequence of workflow steps is initiated. Further, the work item is routed to the correct step in the work flow. Furthermore, the work item is routed to a correct work queue.

At block 238, it is determined whether the confidence level is high for the work item. At block 240, the work item is sent for manual processing if the confidence level is not high. At block 242, the work item is assigned to agents for manual actions. For example, the work item is routed to the correct step/queue (e.g., a high value invoice queue in an approval workflow step). In some embodiments, the manual actions of agents are recorded along with reasons (e.g., a new keyword, a phrase, a pattern and the like to identify the manual action being performed). Further, the changes are fed back to update the transformation rules for obtaining an enhanced confidence level for a next business process transaction. For any complex modifications, agent's manual intervention is required to improve the training data set. At block 244, it is identified whether there is an automatic action to be performed in the workflow step or queue. If the automatic action is not identified the process steps from block 240 are then repeated. At block 246, automatic action (e.g., approvals, updates and the like) is performed on the work item if the automatic action is identified.

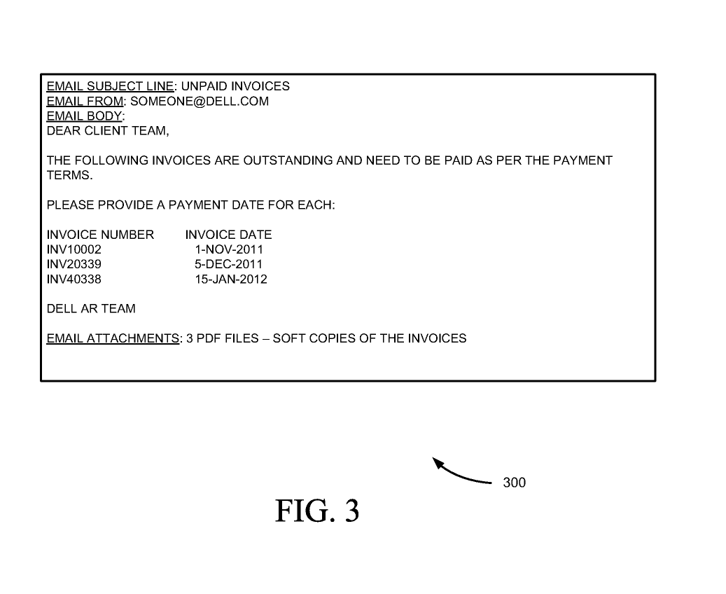

Referring now to FIG. 3, which illustrates an example email 300 received in the high volume shared services environment. The received email 300 includes an email subject line, recipient details, an email body, and email attachments. In one embodiment, the received email is validated based on a known list of senders, an auto- reply, an out of office email and the like. In some scenarios, an email from known senders is received which need to be ignored/rejected automatically. Further, header information, such as the email subject line, date and time of receipt, a sender name, a vendor name, a vendor code, vendor payment terms, the recipient details and the like are extracted and added to a BEM. In some embodiments, fields like the vendor code and the vendor payment terms are auto-populated based on the identified vendor name (i.e., header level information) and assumed to be master data.

Furthermore, the email body is read and stored for further processing. In addition, the email attachments are extracted, parsed and read for information based on configuration. The information is in an unstructured format until the information is converted to the BEM. Also, a list of templates is identified based on the email subject line. In one embodiment, the received email includes a predefined subject line (e.g. sent by some client system on a periodic basis) where all information can be captured without using unstructured data. For example, if the email subject line is “payment status of invoice #INV10002” then there will be enough a confidence level based on keywords, such as ‘invoice #’, ‘payment status’ and the like and required actions are performed without considering the unstructured data.

Also, from text mining configurations, it is realized that the payment status is requested for a set of invoices (i.e., tries to populate the BEM based on the configuration and assigns a confidence level). Moreover, an overall confidence level of 90 is assigned, which is above the threshold defined for the business process. Further, it is determined whether the BEM can be populated further based on the contents of the attachments, file name and metadata. Each configuration can be specific to a file name, a file type and the like. Furthermore, a list of invoices in the received email is identified.

In addition, a workflow is initiated for the helpdesk process upon executing all the text mining configurations. In one embodiment, the workflow is initiated based on the header information (e.g., an email id to which the email was received). For example, since the email is received from a preferred vendor, a work queue to which the work item is routed is determined. The determined work queue is a preferred vendor queue. Moreover, payment status for each invoice is retrieved by automatically querying a payment system using the list of invoices. If all payment statuses are retrieved, then a new mail which details out the status for each invoice is composed and a reply is sent. The reply may be auto-sent or could wait for manual intervention based on the configurations in the workflow. If all payment statuses are not retrieved, the work item is routed to agents where manual intervention can be done. In some embodiments, an email is received where a confidence level is computed to be very low. The work item for the received email is then created in the proper queue for manual agent processing.

In some embodiments, the agents are asked to select from a set of defined reasons to identify how the agents has identified the BEM from the email. Further, the transformation rules are auto-modified to incorporate the scenarios (e.g., a new keyword, such as “invoice no” and the like helped to determine the invoice number, or a pattern, such as an email received from ‘xyz.com’ including INV# in the subject line). In case of complex changes, such as a new file type, a new query type etc., manual intervention is required to modify the transformation rules.

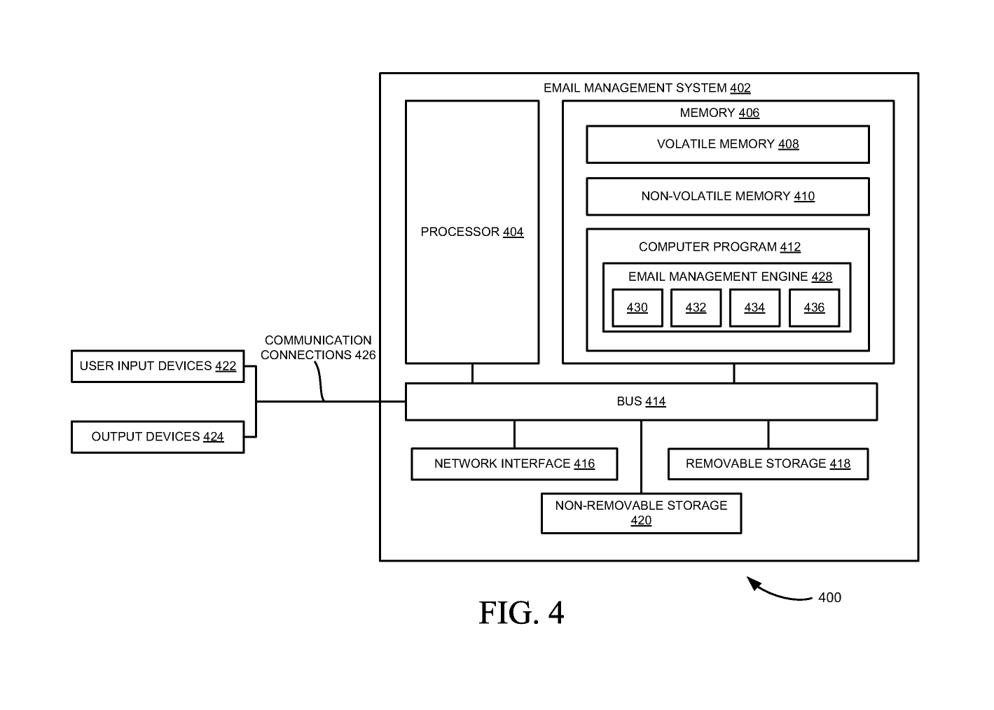

Referring now to FIG. 4, which illustrates an email management system (EMS) 402 including an email management engine 428 for processing the emails in the high volume shared services environment for initiating and processing transactions, using the processes described with reference to FIGS. 1 and 2A-B, according to one embodiment. FIG. 4 and the following discussions are intended to provide a brief, general description of a suitable computing environment in which certain embodiments of the inventive concepts contained herein are implemented.

The EMS 402 includes a processor 404, memory 406, a removable storage 418, and a non-removable storage 420. The EMS 402 additionally includes a bus 414 and a network interface 416. As shown in FIG. 4, the EMS 402 includes access to the computing system environment 400 that includes one or more user input devices 422, one or more output devices 424, and one or more communication connections 426 such as a network interface card and/or a universal serial bus connection.

Exemplary user input devices 422 include a digitizer screen, a stylus, a trackball, a keyboard, a keypad, a mouse and the like. Exemplary output devices 424 include a display unit of the personal computer, a mobile device, and the like. Exemplary communication connections 426 include a local area network, a wide area network, and/or other network.

The memory 406 further includes volatile memory 408 and non-volatile memory 410. A variety of computer-readable storage media are stored in and accessed from the memory elements of the EMS 402, such as the volatile memory 408 and the non- volatile memory 410, the removable storage 418 and the non-removable storage 420. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 404, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 404 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 404 of the EMS 402. For example, a computer program 412 includes machine-readable instructions capable of processing the emails in the high volume shared services environment for initiating and processing transactions in the EMS 402, according to the teachings and herein described embodiments of the present subject matter. In one embodiment, the computer program 412 is included on a compact disk-read only memory (CD-ROM) and loaded from the CD-ROM to a hard drive in the non-volatile memory 410. The machine-readable instructions cause the EMS 402 to encode according to the various embodiments of the present subject matter.

As shown, the computer program 412 includes the email management engine 428. Further, the email management engine 428 includes a gateway services engine 430, an identification engine 432, an execution engine 434, and a rules engine 436. In one embodiment, the gateway services engine 430 performs the process steps 202 to 208 of FIG. 2A. Further in this embodiment, the identification engine 432 performs the process steps 210 to 214 and 232 to 236 of FIG. 2A. Furthermore in this embodiment, the execution engine 434 performs the process steps 238 to 246 of FIG. 2A. In addition in this embodiment, the rules engine 436 performs the process steps 216 to 228 of FIG. 2B. For example, the email management engine 428 can be in the form of instructions stored on a non-transitory computer-readable storage medium. The non-transitory computer-readable storage medium having the instructions that, when executed by the EMS 402, causes the EMS 402 to perform the one or more methods described in FIGS. 1 through 3.

In one embodiment, the gateway services engine 430 validates a received email for further processing. In one exemplary implementation, the gateway services engine 430 validates the received email based on a set of functional rules and attributes, such as the received email should have at least one attachment and the like and a set of relevant parameters, such as relevant sources or pre-defined set of vendors, out of office emails, ignoring auto-generated emails and the like. Further, the gateway services engine 430 routes the validated email to extract business data upon successful validation. Furthermore, the gateway services engine 430 extracts the business data by parsing data in the validated email. Exemplary data includes structured and/or unstructured data. In one embodiment, the gateway services engine 430 extracts the business data by parsing the data in the validated email using industry standard text extraction algorithms. For example, parsing the data includes parsing email header text, email body text, text from one or more embedded files/images, text from one or more attached documents and the like.

In addition, the identification engine 432 transforms the extracted business data into structured business data. In one exemplary implementation, the identification engine 432 transforms the extracted business data into structured business data using transformation rules. Moreover, the identification engine 432 computes any needed additional business data from the transformed business data. Also, the rules engine 436 assigns a confidence level for the transformed business data. In one embodiment, the rules engine 436 determines relevant business data from the transformed business data. Further, the rules engine 436 determines associated one or more rules for validating and applicability of the determined relevant business data. Furthermore, the rules engine 436 compares determined one or more rules with the relevant business data. In addition, the rules engine 436 assigns the confidence level to the relevant business data based on the outcome of the comparison.

Also, the identification engine 432 determines associated one or more business processes based on the transformed business data and the associated confidence level. Further, the identification engine 432 initiates associated one or more business process transactions based on the determined one or more business processes. Furthermore, the execution engine 434 routes the one or more business process transactions to the associated one or more business process transaction queues. For example, routing the one or more business process transactions includes allocating and sending the one or more business process transactions to a right path, to a right queue, and to a right user. In one embodiment, the execution engine 434 automatically routes the one or more business process transactions to the associated one or more business process transaction queues based on the confidence level associated with the business data.

In addition, the execution engine 434 executes the routed one or more business process transactions based on the confidence level associated with the business data and business data thresholds. In one exemplary implantation, the execution engine 434 executes the routed one or more business process transactions using proprietary best practices based on the confidence level associated with the transformed business data and the business data thresholds. Further, the execution engine 434 automatically or manually executes the one or more business process transactions based on the confidence level associated with the transformed business data and the business data thresholds. In one exemplary implementation, the execution engine 434 automatically executes the one or more business process transactions based on classification and indexing parameters, such as automatically responding using standardized templates, automatically escalating using standardized templates, automatically upgrading priorities of jobs, raising alerts to pre-configured people with pre-defined urgency levels, automatically approving based on values and pre-defined thresholds, automatically sending for approval to designated authorities and the like. Moreover, the identification engine 432 updates the transformation rules for obtaining an enhanced confidence level for a next business process transaction.

In various embodiments, systems and methods described with reference to FIGS. 1 through 4 propose the email management engine for processing the emails in the high volume shared services environment for initiating and processing the transactions. Further, the email management engine can read the unstructured and unformatted body of the email intelligently for initiating and processing the transactions. Thus reducing errors and time required for initiating and processing the transactions and also the manual intervention for initiating and processing the transactions. Further, email management engine increases ability to override the system-driven parsing of information.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for processing electronic mails (emails) in a high volume shared services environment for initiating and processing transactions, comprising:
extracting business data by parsing data in a received email;
determining associated one or more business processes based on the extracted business data;
initiating associated one or more business process transactions based on the determined one or more business processes;
routing the one or more business process transactions to the associated one or more business process transaction queues; and
executing the routed one or more business process transactions.

2. The computer implemented method of claim 1, wherein the data in the received email comprises structured data and/or unstructured data.

3. The computer implemented method of claim 1, wherein parsing the data in the received email comprises:
parsing the data selected from the group consisting of email header text, email body text, text from one or more embedded files/images, and text from one or more attached documents.

4. The computer implemented method of claim 1, further comprising:
validating the received email for further processing; and
routing the validated email to extract the business data upon successful validation.

5. The computer implemented method of claim 1, further comprising:
transforming the extracted business data into structured business data using transformation rules; and
computing any needed additional business data from the transformed business data.

6. The computer implemented method of claim 1, further comprising:
determining relevant business data from the extracted business data;
determining associated one or more rules for validating and applicability of the determined relevant business data;
comparing the determined one or more rules with the relevant business data; and
assigning a confidence level to the relevant business data based on the outcome of the comparison.

7. The computer implemented method of claim 6, wherein executing the routed one or more business process transactions comprises:
executing the routed one or more business process transactions based on the confidence level associated with the business data and business data thresholds.

8. The computer implemented method of claim 7, wherein executing the routed one or more business process transactions comprises:
executing the routed one or more business process transactions using proprietary best practices based on the confidence level associated with the business data and the business data thresholds.

9. The computer implemented method of claim 7, wherein executing the routed one or more business process transactions comprises:
automatically or manually executing the routed one or more business process transactions based on the confidence level associated with the business data and the business data thresholds.

10. The computer implemented method of claim 9, wherein automatically executing the routed one or more business process transactions comprises:
automatically executing the routed one or more business process transactions based on classification and indexing parameters selected from the group consisting of automatically responding using standardized templates, automatically escalating using standardized templates, automatically upgrading priorities of jobs, raising alerts to pre-configured people with pre-defined urgency levels, automatically approving based on values and pre-defined thresholds, and automatically sending for approval to designated authorities.

11. The computer implemented method of claim 1, further comprising:
updating transformation rules to obtain an enhanced confidence level for a next business process transaction.

12. An email management system (EMS) for processing electronic mails (emails) in a high volume shared services environment for initiating and processing transactions, comprising:
a processor;
memory coupled to the processor; and
an email management engine residing in the memory, wherein the email management engine comprises:
a gateway services engine for extracting business data by parsing data in a received email;
an identification engine for:
determining associated one or more business processes based on the extracted business data; and
initiating associated one or more business process transactions based on the determined one or more business processes; and
an execution engine for:
routing the one or more business process transactions to the associated one or more business process transaction queues; and
executing the routed one or more business process transactions.

13. The EMS of claim 12, wherein the data in the received email comprises structured data and/or unstructured data.

14. The EMS of claim 12, wherein parsing the data in the received email comprises:
parsing the data selected from the group consisting of email header text, email body text, text from one or more embedded files/images, and text from one or more attached documents.

15. The EMS of claim 12, wherein the gateway services engine is further configured to:
validate the received email for further processing; and
route the validated email to extract the business data upon successful validation.

16. The EMS of claim 12, wherein the identification engine is further configured to:
transform the extracted business data into structured business data using transformation rules; and
compute any needed additional business data from the transformed business data.

17. The EMS of claim 12, wherein the email management engine further comprises a rules engine, wherein the rules engine is configured to:
determine relevant business data from the extracted business data;
determine associated one or more rules for validating and applicability of the determined relevant business data;
compare the determined one or more rules with the relevant business data; and
assign a confidence level to the relevant business data based on the outcome of the comparison.

18. The EMS of claim 17, wherein the execution engine is configured to:
execute the routed one or more business process transactions based on the confidence level associated with the business data and business data thresholds.

19. The EMS of claim 18, wherein the execution engine is configured to:
execute the routed one or more business process transactions using proprietary best practices based on the confidence level associated with the business data and the business data thresholds.

20. The EMS of claim 18, wherein the execution engine is configured to:
automatically or manually execute the routed one or more business process transactions based on the confidence level associated with the business data and the business data thresholds.

21. The EMS of claim 20, wherein the execution engine is configured to:
automatically execute the routed one or more business process transactions based on classification and indexing parameters selected from the group consisting of automatically responding using standardized templates, automatically escalating using standardized templates, automatically upgrading priorities of jobs, raising alerts to pre- configured people with pre-defined urgency levels, automatically approving based on values and pre-defined thresholds, and automatically sending for approval to designated authorities.

22. The EMS of claim 12, the identification engine is further configured to:
update transformation rules to obtain an enhanced confidence level for a next business process transaction.

23. At least one non-transitory computer-readable storage medium for processing electronic mails (emails) in a high volume shared services environment for initiating and processing transactions, when executed by a computing device, cause the computing device to:
extract business data by parsing data in a received email;
determine associated one or more business processes based on the extracted business data;
initiate associated one or more business process transactions based on the determined one or more business processes;
route the one or more business process transactions to associated one or more business process transaction queues; and
execute the routed one or more business process transactions.
